(19) United States
(12) Patent Application Publication
(10) Pub. No.: US 2024/0394394 A1
(43) Pub. Date: Nov. 28, 2024

(54) METHOD FOR RECOGNIZING THEFT OF TRAINED MACHINE LEARNING MODULES, AND THEFT REPORTING SYSTEM

(71) Applicant: Siemens Aktiengesellschaft, München (DE)

(72) Inventors: Anja von Beuningen, Erfurt (DE); Michel Tokic, Tettnang (DE); Boris Scharinger, Fürth (DE); Ferdinand Strixner, München (DE)

(21) Appl. No.: 18/714,156

(22) PCT Filed: Nov. 15, 2022
(86) PCT No.: PCT/EP2022/081947

§ 371 Date: May 29, 2024

(30) Foreign Application Priority Data
Dec. 3, 2021 (EP) 21212249.3

(51) Int. Cl. G06F 21/62

(52) U.S. Cl. CPC G06F 21/6218

(57) ABSTRACT

Provision is made to read in masking information specifying a portion of an output signal from a first machine learning module that is tolerable in terms of controlling the machine. The first machine learning module is expanded with an additional output layer into which the output signal is fed and which inserts a digital watermark into the tolerable portion of the output signal on the basis of the masking information and which outputs the output signal modified in this way. The expanded first machine learning module is then transferred to a user. When a second machine learning module is received, the masking information is used to check whether the tolerable portion of an output signal from the second machine learning module contains the digital watermark. An alarm signal is then output depending on the check result.

### CROSS-REFERENCE TO RELATED APPLICATIONS

This application claims priority to PCT Application No. PCT/EP2022/081947, having a filing date of Nov. 15, 2022, which claims priority to EP Application No. 21212249.3, having a filing date of Dec. 3, 2021, the entire contents both of which are hereby incorporated by reference.

### FIELD OF TECHNOLOGY

The following relates to a method for recognizing theft of trained machine learning modules, and theft reporting system.

### BACKGROUND

Complex machines, such as for example robots, motors, production plants, machine tools, gas turbines, wind turbines or motor vehicles, generally require complex control and monitoring methods for productive and stable operation. In modern machine controllers, machine learning techniques are often used for this purpose. Thus, for example, a neural network may be trained as a control model to control a machine in an optimized way.

However, training neural networks or other machine learning modules for controlling complex machines often proves to be very laborious. For instance, generally large amounts of training data, considerable computing resources and very specific expert know-how are required. Therefore, there is a great interest in protecting trained machine learning modules against uncontrolled or unauthorized distribution and in particular in recognizing theft.

For recognizing the theft of trained neural networks, it is known to provide their neural weights with a unique digital watermark before they are put into service. An existing neural network can then be checked on the basis of the watermark for whether it originates from the user of the watermark. The above method presupposes however access to the neural weights or to the training of the neural network. Neural networks trained by third parties cannot be readily marked in this way.

### SUMMARY

An aspect relates to a method for recognizing theft of a trained machine learning module and a corresponding theft reporting system that can be used more widely.

According to a first aspect of embodiments of the invention, for recognizing the theft of a first machine learning module, which is trained to output on the basis of an input signal an output signal for controlling a machine, an item of masking information by which a part of the output signal that is tolerable in terms of controlling the machine is specified is read in. Furthermore, the first machine learning module is expanded by adding an additional output layer, into which
the output signal is fed,
which on the basis of the masking information inserts a digital watermark into the tolerable part of the output signal and
which outputs the thus-modified output signal.

The expanded first machine learning module is then transferred to a user. When there is a received second machine learning module, it is checked on the basis of the masking information whether the tolerable part of an output signal of the second machine learning module contains the digital watermark. Dependent on the result of the check, an alarm signal is then output. Recognition of the digital watermark generally allows authenticity of the second machine learning module to be affirmed.

An advantage of embodiments of the invention can be seen in particular in that no access to its training process or its model parameters is required for the protection of the first machine learning module. Instead, even fully trained machine learning modules can be protected against uncontrolled distribution, in particular even by third-party suppliers. In addition, the method according to embodiments of the invention can be used flexibly and in particular is not restricted to artificial neural networks. In many cases, the method according to embodiments of the invention can to a certain extent be used as a black box method.

According to an embodiment of the invention, output signals output by the additional output layer may be counted by a counter. Then, the digital watermark may be inserted into the tolerable part of a respective output signal dependent on a counter reading of the counter. In this way, the output signal can for example be cyclically modified or modulated. In embodiments, only after a prescribed number of output signals can the watermark or parts of it be respectively inserted into a then-present output signal. In this way, it can be effectively made more difficult for an unauthorized person to infer the digital watermark from the output signals.

According to an embodiment of the invention, different parts of the digital watermark may be selected and inserted into the tolerable part of a respective output signal dependent on the counter reading. In this way, the digital watermark can for example be cyclically distributed over multiple output signals. In the case of a digital watermark represented by a bitstring of the length N, it can thus be decided by calculating a remainder from the division of the counter reading with respect to N which of the N bits is inserted into a relevant output signal.

According to an embodiment of the invention, the digital watermark may be inserted into the tolerable part of a respective output signal dependent on a random process.

According to an embodiment of the invention, an interface between the first machine learning module and the additional output layer may be protected against external access. In embodiments, the additional output layer may be encapsulated with the first machine learning module in a signature-protected data or program container, for example a Docker container. In this way, the watermark protection can be protected against unauthorized manipulation.

According to an embodiment of the invention, the second machine learning module may be used for controlling the machine, the alarm signal then being output if the tolerable part of the output signal of the second machine learning module does not contain the digital watermark. In this way, it can in many cases be ensured that only authorized copies of a machine learning module are used or can be used for controlling the machine.

According to an embodiment of the invention, the second machine learning module may be installed and run in an edge computing environment. Furthermore, it may be checked whether the tolerable part of the output signal of the second machine learning module contains the digital watermark. Dependent on the result of the check, the second machine learning module can then be used for controlling the machine.

According to a further aspect of embodiments of the invention, for recognizing the theft of a first machine learning module which is trained to output on the basis of an input signal an output signal for controlling a machine, a test input signal that does not occur in the control of the machine is determined. The test input signal is then fed into the first machine learning module and a resulting output signal of the first machine learning module is stored as the digital watermark. The first machine learning module is then transferred to a user. When there is a received second machine learning module, the test input signal is fed into the second machine learning module and it is checked whether the resulting output signal matches the stored digital watermark. Dependent on the result of the check, an alarm signal is then output.

According to an embodiment of the above method, the first machine learning module may be expanded by adding an additional input layer. The additional input layer may check an incoming input signal for whether it matches the test input signal and, given a positive result of the check, make the first machine learning module output an output signal by which characteristic properties of the first machine learning module are specified. The characteristic properties can be used as a digital watermark or as part of it. In the case of an artificial neural network for example, a number of neural layers, a number of neurons or other topology or model parameters may be specified as characteristic properties. Where in the case of independently created machine learning modules there is a very high probability that such model parameters do not completely match, a larger set of such model parameters may in many cases serve as a digital fingerprint of a machine learning module, and consequently also as a watermark.

According to an embodiment of the method according to the invention, an output signal containing the digital watermark may be output via a different output channel than an output signal not containing the digital watermark. In embodiments, an output signal containing the digital watermark, or a signal derived from it, may be transmitted to the machine as a control signal, whereas an output signal not containing the digital watermark is output via a service channel. In this way, the machine to be controlled is protected against being controlled by unauthentic machine learning modules.

In embodiments, the method according to the first aspect of the invention and the second aspect of the invention may also be combined with one another. In this way, the reliability of the theft recognition can in many cases be increased.

For carrying out the methods according to embodiments of the invention, a theft reporting system, a computer program product (non-transitory computer readable storage medium having instructions, which when executed by a processor, perform actions) and a computer-readable, non-volatile, storage medium are provided.

### BRIEF DESCRIPTION

Some of the embodiments will be described in detail, with references to the following Figures, wherein like designations denote like members, wherein:

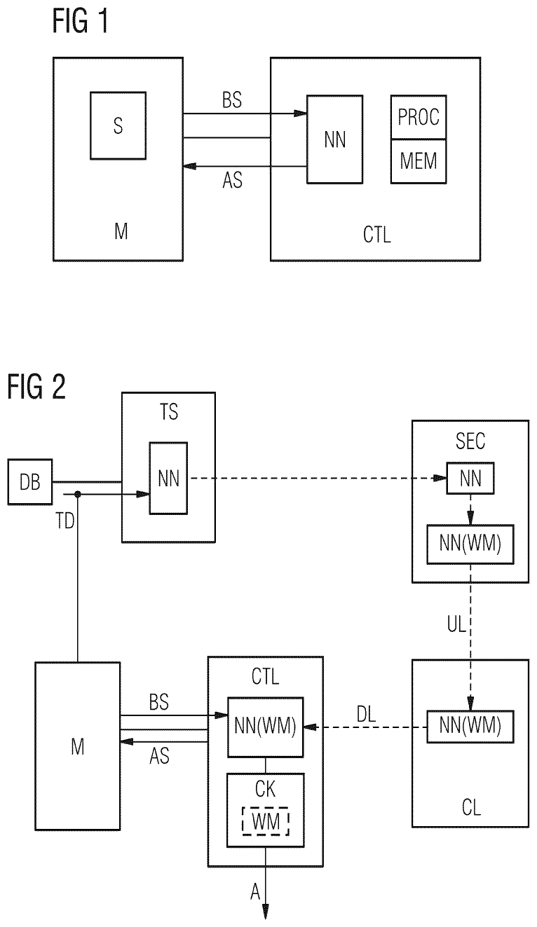

FIG. 1 shows a control of a machine by a machine learning module;

FIG. 2 shows a theft reporting system for a machine learning module;

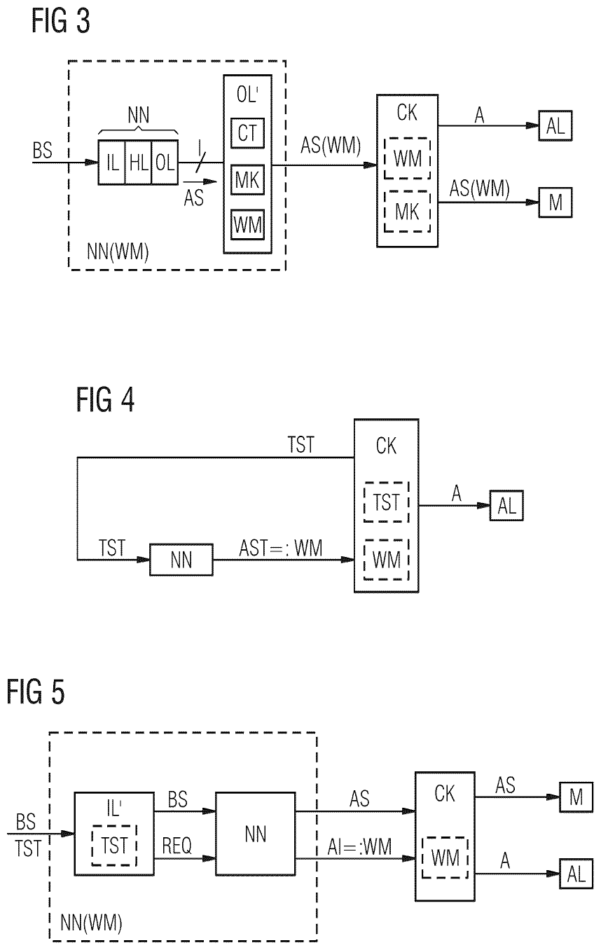

FIG. 3 shows a first exemplary embodiment of a verification of a machine learning module;

FIG. 4 shows a second exemplary embodiment of a verification of a machine learning module and

FIG. 5 shows a third exemplary embodiment of a verification of a machine learning module.

### DETAILED DESCRIPTION

FIG. 1 illustrates a control of a machine M by a trained machine learning module NN in a schematic representation. Here, the machine M may be in particular a robot, a motor, a production plant, a machine tool, a turbine, an internal combustion engine and/or a motor vehicle or comprise such a machine. For the present exemplary embodiment, it will be assumed that the machine M is a production robot.

The machine M is controlled by a machine controller CTL coupled to it. The latter is shown outside the machine M in FIG. 1. As an alternative to this, the machine controller CTL may also be entirely or partially integrated in the machine M.

The machine controller CTL has one or more processors PROC for performing method steps according to embodiments of the invention and one or more memories MEM for storing data to be processed.

The machine M has a sensor system S, by which operating parameters of the machine M and other measured values are continually measured. The measured values determined by the sensor system S are transmitted together with other operating data of the machine M in the form of operating signals BS from the machine M to the machine controller CTL.

The operating signals BS comprise in particular sensor data and/or measured values of the sensor system S, control signals and/or state signals of the machine M. Here, the state signals respectively specify an operating state of the machine M or of one or more of its components, over the course of time. In embodiments, a power output, a rotational speed, a torque, a speed of movement, an exerted or acting force, a temperature, a pressure, current resource consumption, available resources, pollutant emissions, vibrations, wear and/or loading of the machine M or of components of the machine M may be quantified by the operating signals BS. In an embodiment, the operating signals BS are respectively represented by numerical data vectors and transmitted in this form to the machine controller CTL.

The machine controller CTL also has a trained machine learning module NN for controlling the machine M. The machine learning module NN is trained to output on the basis of a fed-in input signal an output signal by which the machine M can be controlled in an optimized way. A large number of efficient machine learning methods, in particular methods of reinforcement learning, are available for training such a machine learning module NN. The training of the machine learning module NN is discussed in more detail below. The machine learning module NN may be implemented in particular as an artificial neural network.

For controlling the machine M, the operating signals BS, or operating data derived from them, are fed as an input signal into an input layer of the trained machine learning module NN. From the input signal, an output signal AS is derived by the trained machine learning module NN. The output signal AS, or a signal derived from it, is then transmitted as a control signal to the machine M in order to control it in an optimized way.

FIG. 2 illustrates a theft reporting system for a machine learning module NN.

The machine learning module NN, for example an artificial neural network, is trained in a training system TS to output on the basis of a fed-in input signal an output signal by which the machine M can be controlled in an optimized way. The training is performed on the basis of a large amount of training data TD, which originates from a database DB or from the machine M or a machine similar to it.

Training should be understood here generally as optimization of a mapping of an input signal of a machine learning module onto its output signal. This mapping is optimized during a training phase on the basis of prescribed learned criteria and/or criteria to be learned. In the case of prediction models, a prediction error may be used in particular as a criterion and, in the case of control models, a success of a controlling action may be used in particular as a criterion. By the training, for example networking structures of neurons of a neural network and/or weights of connections between the neurons may be set or optimized such that the prescribed criteria are satisfied as well as possible. The training can consequently be understood as an optimization problem.

A large number of efficient optimization methods are available for such optimization problems in the field of machine learning, in particular gradient-based optimization methods, gradient-free optimization methods, back propagation methods, particle swarm optimizations, genetic optimization methods and/or population-based optimization methods. In embodiments, artificial neural networks, recurrent neural networks, convolutional neural networks, perceptrons, Bayesian neural networks, autoencoders, variational autoencoders, Gaussian processes, deep learning architectures, support vector machines, data-driven regression models, k nearest neighbor classifiers, physical models and/or decision trees are able to be trained.

In the case of the machine learning module NN provided for controlling the machine M, as input signals it is supplied with operating signals of the machine M that are contained in the training data TD. In the course of the training, neural weights of the machine learning module NN are set by an aforementioned optimization method in such a way that the machine M is controlled in an optimized way by the output signals derived by the machine learning module NN from the input signals. For assessing optimized control of the machine M, for example a performance of the machine M, for example a power output, an efficiency etc., may be measured and used as an optimization criterion.

The machine learning module NN trained in this way is subsequently transferred from the training system TS to a security system SEC. The security system SEC serves the purpose of protecting the trained machine learning module NN against uncontrolled or unauthorized distribution, in that a digital watermark WM is impressed on the trained machine learning module NN or a digital fingerprint of the trained machine learning module NN, which can be used as a digital watermark WM, is determined.

The machine learning module NN(WM) protected by the watermark WM is transferred from the security system SEC by an upload UL into a cloud CL, in particular into an app store of the cloud CL.

From the cloud CL or its app store, the protected machine learning module NN(WM) is downloaded by a download DL by a user who would like to control the machine M with the aid of this machine learning module NN(WM).

For this purpose, the protected machine learning module NN(WM) is installed by the machine controller CTL in an edge computing environment or in the cloud CL and is executed in a runtime environment of the edge computing environment or the cloud CL. In this case, as described above, the machine learning module NN(WM) is supplied with operating signals BS of the machine M as input signals. The output signals AS of the machine learning module NN(WM) resulting from this, or signals derived from them, are transmitted from the machine controller CTL as control signals to the machine M, as likewise described above.

The edge computing environment may be implemented as part of an edge computing platform, for example the “industrial edge” of the Siemens AG company. The protected machine learning module NN(WM) may in this case be encapsulated for example in a Docker container.

The machine controller CTL also contains a checking device CK, which is coupled to the machine learning module NN(WM) and by which it is checked whether an output signal AS of the machine learning module NN(WM) is marked with the watermark WM. For checking, in particular a pattern comparison between the output signal AS or part of it and the watermark WM may be carried out by the checking device CK. In this case, a match, an approximate match or a similarity of the compared patterns may be used as a criterion for a presence of the watermark WM. In embodiments, a possibly weighted Euclidean distance between data vectors representing the compared patterns may be determined. A presence of the watermark WM may be signaled for example whenever the Euclidean distance is below a prescribed threshold value.

If the watermark WM is recognized in the output signals AS by the checking device CK, the output signals AS, or control signals derived from them, are transmitted via a control channel for controlling the machine M to the latter. Otherwise, the output signals AS are output via a separate service channel of the machine controller CTL together with an alarm signal A. In this way it can be prevented that the machine M is controlled by an unauthorized machine learning module and at the same time the user or a creator of the machine learning module can be informed by the alarm signal A about an unauthorized or falsified machine learning module.

As an alternative to this, if the watermark WM is recognized, the checking device CK may output an alarm signal and for example transfer it to a creator of the machine learning module in order to inform the latter that an existing machine learning module originates from it and has possibly been used or brought into service unauthorized.

FIG. 3 illustrates a first exemplary embodiment of a verification according to embodiments of the invention of a trained machine learning module NN, which is designed as an artificial neural network. The latter has an input layer IL, one or more hidden layers HL and an output layer OL.

To protect the trained machine learning module NN, an additional output layer OL′ is coupled to its output layer OL via an interface I, by the security system SEC. The additional output layer OL′ may be a neural layer, a software layer or a call-up routine for the trained machine learning module NN.

The additional output layer OL′ serves for inserting a unique digital watermark WM into output signals AS of the trained machine learning module NN. A bitstring of a prescribed length N may be provided in particular as the digital watermark WM. The digital watermark WM provided is stored in the additional output layer OL′.

The interface I between the trained machine learning module NN and the additional output layer OL′, to be more specific between the output layer OL and the additional output layer OL′, is protected against unauthorized access, for example by encryption or obfuscation. The additional output layer OL′ is combined and/or encapsulated in as inseparable a way as possible with the trained machine learning module NN.

By adding the additional output layer OL′, the trained machine learning module NN is expanded to form a machine learning module NN(WM) protected by the digital watermark WM. The protected machine learning module NN(WM) may be stored or encapsulated in a software or data container which loses its functions if it is opened up. In embodiments, a key- or signature-protected software encapsulation or data encapsulation may be used.

Apart from the digital watermark WM, the additional output layer OL′ also contains an item of masking information MK and a counter CT. A part of the output signal AS that is tolerable in terms of controlling the machine M is specified by the masking information MK. In the present exemplary embodiment, those bits of the output signals AS that have the lowest value or a low value are specified by the masking information MK. Such bits are often also referred to as least significant bits.

The counter CT serves for counting the output signals AS or the evaluations of the trained machine learning module NN. In an embodiment, a maximum counter reading is prescribed for the counter CT, and when this is exceeded the counter reading is reset again to an initial counter reading. In this case, the counting values of the counter CT are run through cyclically. The bit length N of the digital watermark WM may be prescribed for example as the maximum counter reading.

The machine learning module NN(WM) protected by the digital watermark WM may then be passed on to a user, for example as described in conjunction with FIG. 2.

When the protected machine learning module NN(WM) is used for controlling the machine M, its operating signals BS are fed into the input layer IL as input signals. From the operating signals BS, the output signals AS of the trained machine learning module NN are derived by the input layer IL, the hidden layers HL and the output layer OL.

The output signals AS are fed into the additional output layer OL′ from the output layer OL via the interface I. As already mentioned above, the fed-in output signals AS or the corresponding evaluations of the trained machine learning module NN are counted by the counter CT. Dependent on a respective counter reading of the counter CT, the digital watermark WM is then inserted by the additional output layer OL′ into the part of the output signals AS that is specified by the masking information MK.

In an embodiment, dependent on the counter reading, a bit of the digital watermark WM may be selected and the selected bit inserted into the least significant bit of the relevant output signal AS. In embodiments, when there is a counter reading K, the Kth bit of the digital watermark WM may be inserted into the least significant bit of the relevant output signal AS. In this way, the digital watermark WM can be cyclically distributed over multiple output signals.

As an alternative or in addition, it may be provided that only every Lth output signal AS is modified by the digital watermark WM or part of it, where L is a prescribed number of model evaluations. In this way, it can be made more difficult for unauthorized persons to reconstruct the digital watermark WM from output signals.

Inserting the digital watermark WM into the output signals AS of the trained machine learning module NN has the effect of generating output signals AS(WM) modified by the additional output layer OL′, which are output as output signals of the protected machine learning module NN(WM).

The modified output signals AS(WM) are transmitted to a checking device CK. The latter checks on the basis of the masking information MK stored there whether the modified output signals AS(WM) contain the digital watermark WM stored in the checking device CK in the parts specified by the masking information MK, that is to say for example in the least significant bits. If this is the case, the modified output signals AS(WM), or control signals derived from them, are transmitted via a control channel for controlling the machine M to the latter. Otherwise, an alarm signal A is transmitted via a service channel to an alarm signaling device AL. In this way it can be achieved that only authorized copies of the trained machine learning module are used for controlling the machine M or can be used for this purpose.

FIG. 4 illustrates a second exemplary embodiment of a verification according to the invention of an existing trained machine learning module NN.

For later verification, the trained machine learning module NN is supplied with at least one test input signal TST that does not occur in the control of the machine M as an input signal, by the security system SEC. Such a test input signal TST may in particular be generated on a random basis and be compared with stored operating signals from the operation of the machine M, occurring over a representative time period. If a, for example Euclidean, distance from all the operating signals that have occurred is greater than a prescribed threshold value, a thus-generated signal can be accepted as the test input signal TST.

The output signal AST derived by the trained machine learning module NN from the test input signal TST is then stored as the digital watermark WM together with the test input signal TST in a checking device CK.

For the verification of an existing trained machine learning module, here NN, by the checking device CK, the latter feeds the stored test input signal TST into the trained machine learning module NN as an input signal. An output signal derived by the trained machine learning module NN from the test input signal TST is then transmitted to the checking device CK and compared by it with the stored output signal AST.

Where the output signal resulting from the test input signal TST matches the stored output signal AST, possibly within a prescribed tolerance range, the verified machine learning module NN is recognized as originating from the creator of the trained machine learning module NN or from the security system SEC. The thus-verified machine learning module NN can then be used for the authorized controlling of the machine M. Otherwise, as described above, an alarm signal A is transmitted via a service channel to an alarm signaling device AL.

An advantage of the above variant of an embodiment can be seen in particular in that a machine learning module NN to be protected does not have to be modified before it is passed on, but can be identified on the basis of its reaction to an anomalous test input signal TST. This identification is based on the observation that a reaction of a trained machine learning module to an input signal deviating greatly from normal operation is scarcely reproducible by a machine learning module trained any other way. Such a reaction can consequently generally be used as a digital fingerprint or as a unique watermark.

FIG. 5 illustrates a third exemplary embodiment of a verification according to the invention of a trained machine learning module.

According to this variant of an embodiment, to protect a trained machine learning module NN, it is expanded by adding an additional input layer IL′ to form a protected machine learning module NN(WM).

The additional input layer IL′ is coupled to the trained machine learning module NN via an interface protected against unauthorized access, in particular a control interface or an information interface. The additional input layer IL′ may be designed as a software layer, as an input routine, as a call-up routine for execution of the machine learning module NN and/or as a neural layer. A test input signal TST that does not occur in the control of the machine M and can be generated as described above is stored in the additional input layer IL′.

On the basis of the stored test input signal TST, the additional input layer IL′ checks supplied input signals for whether they match the test input signal TST, possibly within a prescribed tolerance range. If this is the case, the additional input layer IL′ uses a request signal REQ to make the trained machine learning module NN output as an output signal an item of architecture information AI, by which characteristic properties of the trained machine learning module NN are specified. Here, the request signal REQ may be transmitted to the trained machine learning module NN or to an interpreter of the trained machine learning module NN.

The architecture information AI may be output via a control interface of the trained machine learning module NN. The characteristic properties of the machine learning module NN that are specified by the architecture information AI may concern in particular its model specification, for example a number of neural layers, a number of neurons or other topology parameters, other architecture particulars and/or learning parameters of the trained machine learning module NN.

Many machine learning modules provide an output of architecture information AI as standard. In the present case, such an output is triggered by the detection of the test input signal TST by the additional input layer IL′.

The output architecture information AI is stored as a watermark WM in the checking device CK. The machine learning module NN(WM) expanded by adding the additional input layer IL′ may be subsequently passed on or uploaded into the cloud CL.

For verifying an existing machine learning module, here NN(WM), it is supplied not only with the operating signals BS of the machine M but also, at least in a randomly sampled manner, with the test input signal TST as an input signal. The additional input layer IL′ checks the fed-in input signals for whether they match the test input signal TST, at least within a prescribed tolerance range. If there is a match, the additional input layer IL′ uses the request signal REQ to make the trained machine learning module NN output an item of architecture information AL. The latter is transferred from the trained machine learning module NN to the checking device CK and compared there with the stored watermark WM, i.e. with the stored architecture information AL.

If there is a match, the verified machine learning module NN(WM) is recognized by the checking device CK as originating from the creator of the trained machine learning module NN or from the security system SEC. In this case, the existing machine learning module NN(WM) can be used for controlling the machine M. I.e., in the further course of proceedings operating signals BS fed into the machine learning module NN(WM) are passed on via the additional input layer IL′ to the trained machine learning module NN. Its output signals AS resulting from this, or control signals derived from them, are then transmitted from the checking device CK to the machine M.

If there is no match between the architecture information AI output by the existing machine learning module and the watermark WM stored in the checking device CK, this machine learning module is correspondingly considered to be unauthentic. In this case, as described above, an alarm signal A may be transmitted from the checking device CK to an alarm signaling device AL.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for recognizing theft of a trained machine learning module, wherein
a) providing a first machine learning module, which is trained to output on the basis of an input signal an output signal for controlling a machine,
b) specifying and reading in an item of masking information by which a part of the output signal that is tolerable in terms of controlling the machine (M),
c) expanding the first machine learning module by adding an additional output layer,
into which the output signal is fed,
which on the basis of the masking information inserts a digital watermark into the tolerable part of the output signal and
which outputs the thus-modified output signal,
d) transferring the expanded first machine learning module to a user,
e) receiving a second machine learning module,
f) checking on the basis of the masking information whether the tolerable part of an output signal of the second machine learning module contains the digital watermark, and
g) outputting, dependent on the result of the check, an alarm signal.

2. The method as claimed in claim 1, wherein output signals output by the additional output layer are counted by a counter, and
in that the digital watermark is inserted into the tolerable part of a respective output signal dependent on a counter reading of the counter.

3. The method as claimed in claim 2, wherein different parts of the digital watermark are selected and inserted into the tolerable part of a respective output signal dependent on the counter reading.

4. The method as claimed in claim 1, wherein the digital watermark is inserted into the tolerable part of a respective output signal dependent on a random process.

5. The method as claimed in claim 1, wherein an interface between the first machine learning module and the additional output layer is protected against external access.

6. The method as claimed in claim 1, wherein in the second machine learning module is used for controlling the machine,
in that the alarm signal is output if the tolerable part of the output signal of the second machine learning module does not contain the digital watermark.

7. The method as claimed in claim 1, wherein the second machine learning module is installed and run in an edge computing environment,
in that it is checked whether the tolerable part of the output signal of the second machine learning module contains the digital watermark, and
in that, dependent on the result of the check, the second machine learning module is used for controlling the machine.

8. A method for recognizing theft of a trained machine learning module, wherein
a) providing a first machine learning module, which is trained to output on the basis of an input signal an output signal for controlling a machines,
b) determining a test input signal that does not occur in the control of the machine,
c) storing the test input signal is fed into the first machine learning module and a resulting output signal of the first machine learning module as the digital watermark,
d) transferring the first machine learning module to a user,
e) receiving a second machine learning module,
f) feeding the test input signal into the second machine learning module and checking whether the resulting output signal matches the stored digital watermark, and
g) outputting dependent on the result of the check, an alarm signal.

9. The method as claimed in claim 8,
wherein the first machine learning module is expanded by adding an additional input layer, which
checks an incoming input signal for whether it matches the test input signal and
given a positive result of the check, makes the first machine learning module output an output signal by which characteristic properties of the first machine learning module are specified.

10. The method as claimed in claim 1, wherein
an output signal comprising the digital watermark is output via a different output channel than an output signal not comprising the digital watermark.

11. A theft reporting system for trained machine learning modules, set up for performing a method as claimed in claim 1.

12. A computer program product, comprising a computer readable hardware storage device having computer readable program code stored there, said program code executable by a processor of a computer system to implement a method set up for performing a method as claimed in claim 1.

13. A computer-readable storage medium with a computer program product as claimed in claim 12.
